(19) United States
(12) Patent Application Publication
(10) Pub. No.: US 2008/0156162 A1
(43) Pub. Date: Jul. 3, 2008

(54) Saw blade protecting plate for a table sawing machine

(76) Inventor: Bor-Yann Chuang, Taiping City (TW)

Correspondence Address: BRUCE H. TROXELL, 5205 LEESBURG PIKE, SUITE 1404, FALLS CHURCH, VA, 22041, US

(21) Appl. No.: 11/647,445

(22) Filed: Dec. 29, 2006

(51) Int. Cl. B26D 1/14

(52) U.S. Cl. 83/478

(57) ABSTRACT

A saw blade protecting plate of a table sawing machine is firmly covered on the work table of a table sawing machine and positioned at a corresponding location of a saw blade. The saw blade protecting plate is composed of a support plate and a covering plate. The support plate made of metal has its surface bored with a lengthwise notch preset in length and width. The covering plate made of plastic is completely covered and bonded on the support plate and covers up the notch between the saw blade and the support plate. Therefore, the saw blade is inserted and fixed in the saw blade protecting plate without leaving gap between them, thus insuring safety in a sawing process.

### BACKGROUND OF THE INVENTION

1. Field of the Invention

This invention relates to a saw blade protecting plate for a sawing machine, particularly to one made of two different materials bonded together and cut with a lengthwise slit by a saw blade for the saw blade to pass therethrough and operate therein, leaving no gap between the saw blade and the saw blade protecting plate, insuring safety in use and lowering producing cost.

2. Description of the Prior Art

A common table sawing machine 10, as shown in FIG. 1, is provided with a work table 11 assembled thereon with a saw blade 12 protected by a saw blade protecting plate 13 and a protective cover unit 130. A conventional metallic saw blade protecting plate 13 has its surface cut with a lengthwise notch 131 for the saw blade 12 to pass therethrough and operate therein, with a gap (h) respectively formed between the saw blade 12 and the opposite edges of the notch 131 to avoid the saw blade 12 colliding with the saw blade protecting plate 13 and causing damage to them. The conventional metallic saw blade protecting plate 13 is shaped by molds so its producing cost is comparatively low. However, in order to avoid the saw blade 12 contacting with the saw blade protecting plate and causing damage, a comparatively large gap (h) is respectively formed between the saw blade 12 and the opposite edges of the notch 131. Thus, during sawing of work piece, wood chips and wood blocks produced in a sawing process are easy to drop in the gaps (h) and be forced to rebound out of table sawing machine 10 by the saw blade 12 rotating at high speeds, most likely to cause injury to the operator.

A conventional non-metallic saw blade protecting plate 14, as shown in FIG. 3, is made of wooden plate, pearlite plate or high-pressure compressed plate. After shaped and covered on the work table 111 of the table sawing machine 10, the saw blade protecting plate 14 has its smooth surface cut with a lengthwise slit 141 by the saw blade 12 when the saw blade 12 is operated to move up from under the saw blade protecting plate 14. Therefore, almost no gap is formed between the saw blade 12 and the opposite edges of the slit 141, thus preventing wood chips from rebounding and injuring the operator in a sawing process.

However, referring to FIG. 4, the saw blade protecting plate 14 made of non-metallic material must increase its thickness (about five times as thick as a metallic saw blade protecting plate) so as to enhance its hardness and strength and prevent it from distorted and deformed. Nevertheless, the conventional table sawing machine 10 generally has a motor and other members installed at one side of the saw blade 12 under the saw blade protecting plate 14; therefore, the saw blade protecting plate 14 must have its underside cut with a plurality of recesses 142 for facilitating assembly of the motor and other members, thus increasing producing cost and influencing competitive capability of industry.

### SUMMARY OF THE INVENTION

The objective of the invention is to offer a saw blade protecting plate for a table sawing machine, which is fixedly covered on the work table of a table sawing machine at a corresponding location of a saw blade. The saw blade protecting plate is composed of a support plate and a covering plate. The support plate made of metal has its surface cut with a lengthwise notch preset in length and width. The covering plate made of plastic is completely covered and bonded on the support plate and covers up the notches between the support plate and the saw blade. The saw blade protecting plate is cut with a lengthwise slit by the saw blade when the saw blade is operated to move up from under the saw blade protecting plate. Therefore, the saw blade is exactly positioned in the cut slit of the saw blade protecting plate, almost leaving no gap between the saw blade and the saw blade protecting plate and thus able to avoid wood chips produced in a sawing process dropping in the slit and causing an accident. In addition, the saw blade protecting plate is made of the metallic support plate and the plastic covering plate bonded and covered on the supporting plate; therefore, the plastic covering plate supported by the support plate is of a certain hardness and not easy to be deformed, able to lower producing cost.

### BRIEF DESCRIPTION OF DRAWINGS

This invention will be better understood by referring the accompanying drawings, wherein:

FIG. 1 is a perspective view of a first conventional table sawing machine;

FIG. 2 is a perspective view of the saw blade protecting plate of the first conventional table sawing machine;

FIG. 3 is a perspective view of the saw blade protecting plate of a second conventional table sawing machine;

FIG. 4 is a cross and perspective view of the saw blade protecting plate of the second conventional table sawing machine;

FIG. 5 is a perspective view of a table sawing machine in the present invention;

FIG. 6 is a perspective view of a first preferred embodiment of a saw blade protecting plate for the table sawing machine in the present invention;

FIG. 7 is a perspective view of the support plate of the saw blade protecting plate in the present invention;

FIG. 8 is a cross-sectional view of the first preferred embodiment of the saw blade protecting plate in the present invention;

FIG. 9 is across-sectional view of the first preferred embodiment of the saw blade protecting plate having its covering plate cut with a lengthwise slit by the saw blade in the present invention; and

FIG. 10 is a cross-sectional view of a second preferred embodiment of a saw blade protecting plate in the present invention.

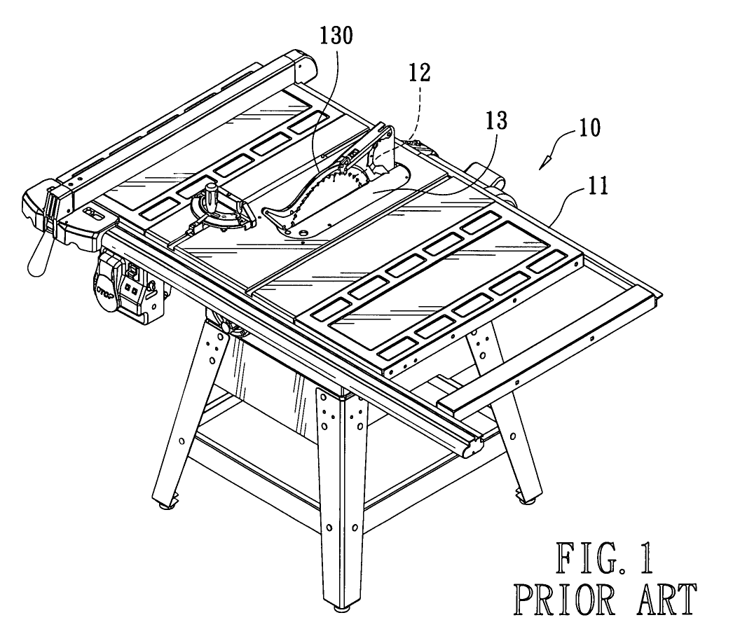

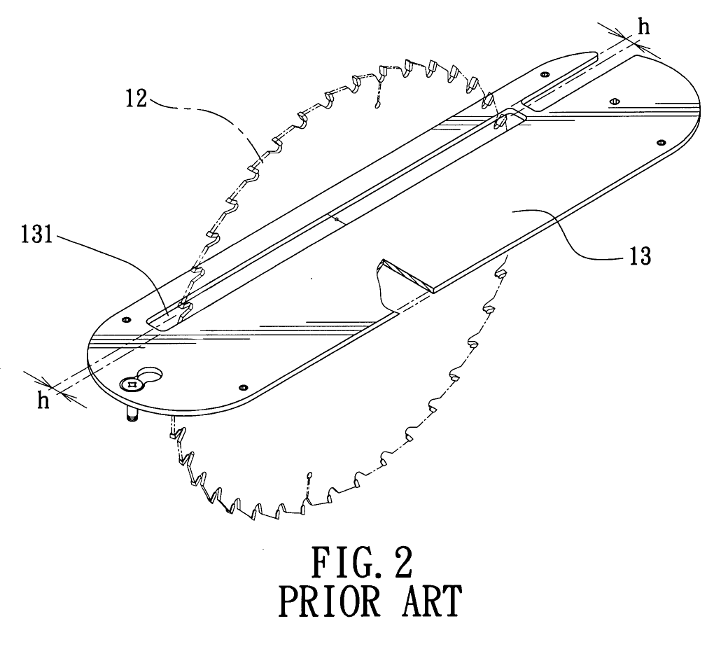

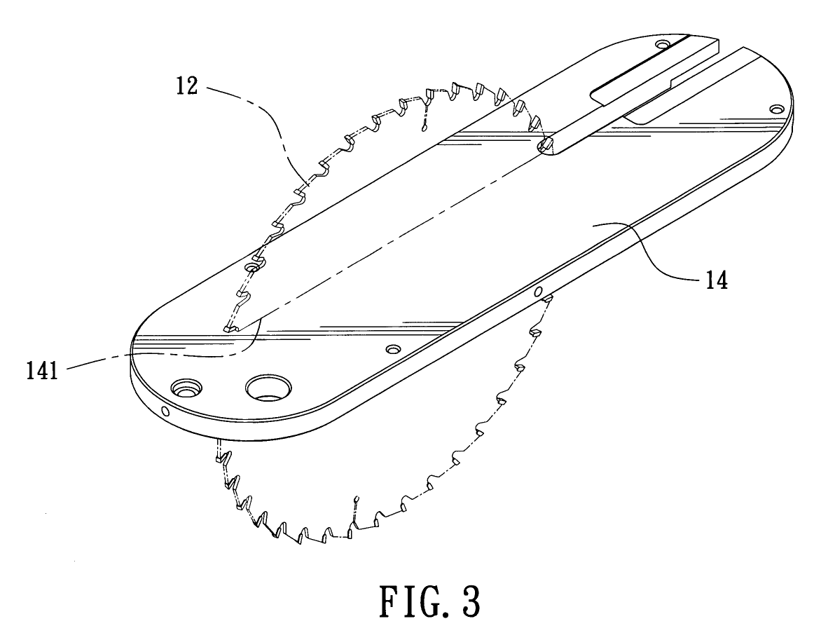

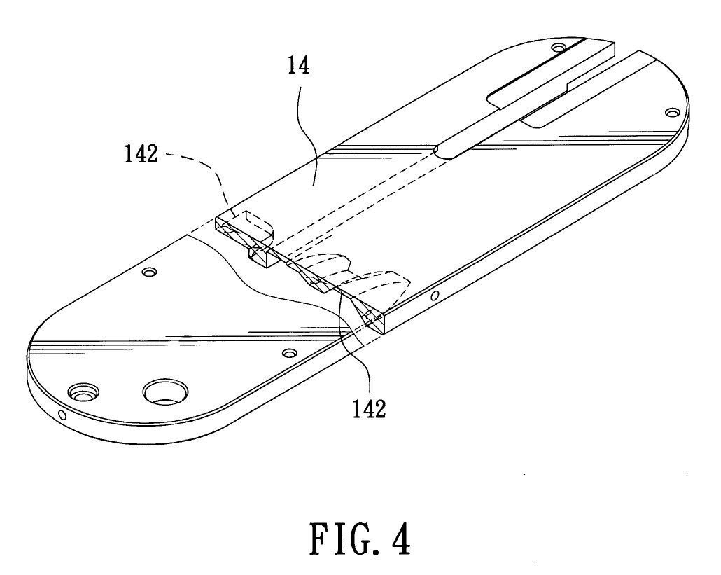

### DETAILED DESCRIPTION OF THE PREFERRED EMBODIMENT

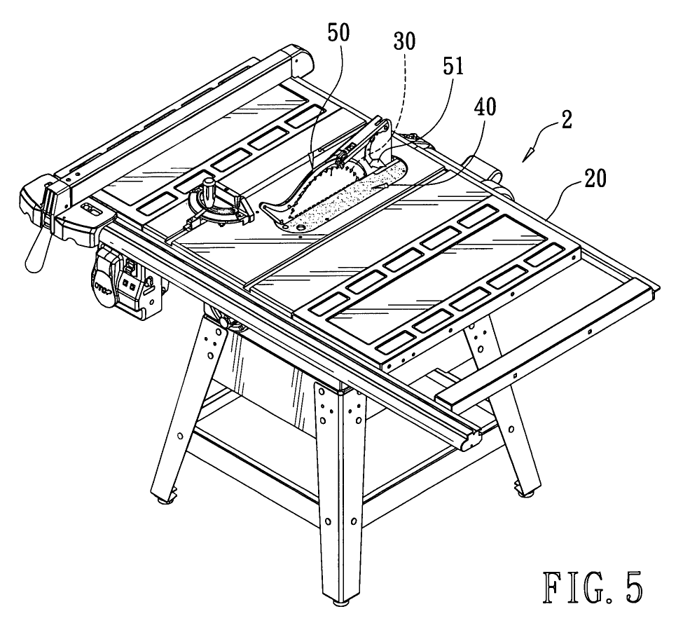

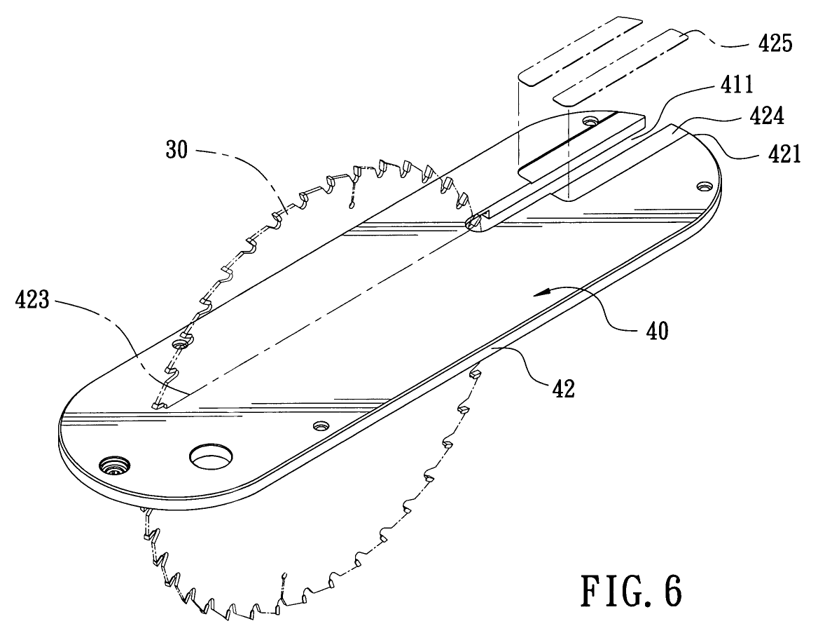

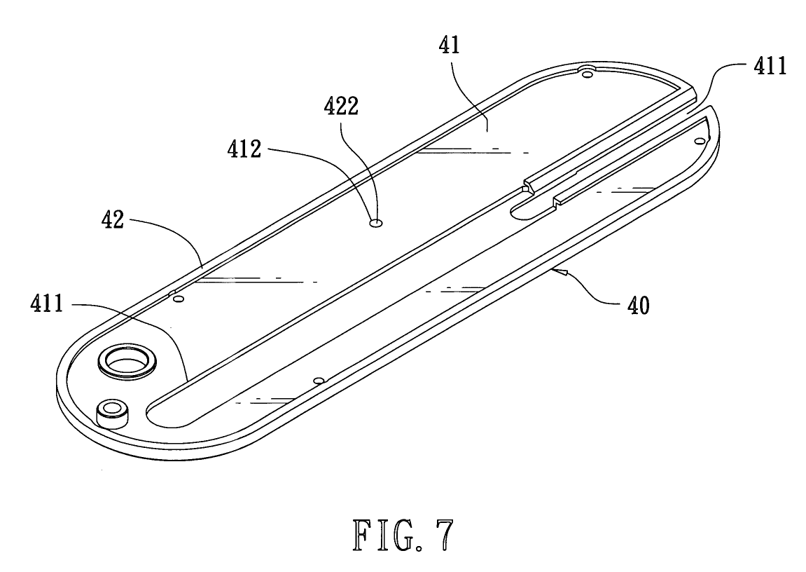

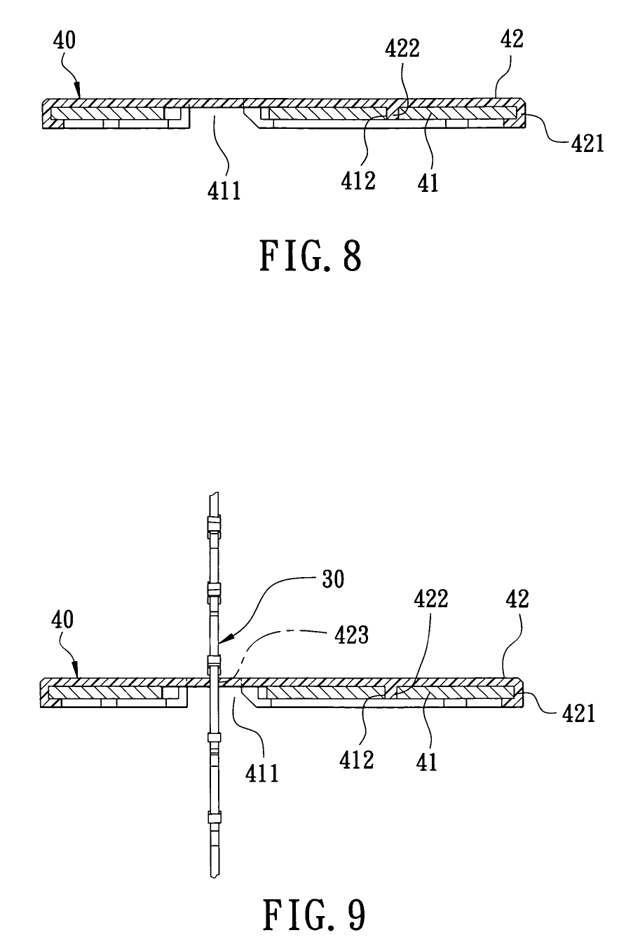

A first preferred embodiment of a saw blade protecting plate for a table sawing machine 2 in the present invention, as shown in FIGS. 5-8, includes a work table 20, a saw blade 30, a saw blade protecting plate 40 and a protective cover unit 50 combined together.

The saw blade protecting plate 40 consists of a support plate 41 and a wrapping plate 42.

The support plate 41 is long, made of metal and formed with a thickness around 2-3 mm. The support plate 41 has its surface bored with a lengthwise notch 411 preset in length and width and aligned to the saw blade 30. The support plate 41 further has its surface bored with a combining hole 412 at a preset location.

The covering plate 42 is made of plastic, able to be cut by the saw blade 30. The covering plate 42 is completely covered and bonded on the support plate 41 and formed with a combining edge 421 covered and bonded on the peripheral edge of the support plate 41. After shaped, the covering plate 42 with a smooth surface and a 2 mm thickness will completely cover the notch 411 between the support plate 41 and the saw blade 30. Further, when the plastic covering plate 42 is injection molded to cover the support plate 41, the combining hole 412 of the support plate 41 will be filled up with plastic, which after cooling can serve as a combining hole 412 of the support plate 41 will be filled strength of the support plate 41 and the covering plate 42. The covering plate 42, as shown in FIG. 9, is cut with a lengthwise slit 423 by the saw blade 30 when the saw blade 30 is operated to move up from under the covering plate 42. Therefore, the saw blade 30 is positioned in the slit 423 of the covering plate 42 almost leaving no gap between the saw blade 30 and the saw blade protecting plate 40.

The protective cover unit 50 is provided with a non-return plate 51, and the covering plate 42 is disposed with two recessed bonding members 424 at the opposite sides of the non-return plate 51 for respectively bonding a hard and abrasion-resistant steel sheet 425 thereon.

Specifically, referring to FIGS. 5, 8 and 9, the saw blade protecting plate 40 is composed of the covering plate 42 and the support plate 41 completely covered by the covering plate 42, and the combining hole 413 of the support plate 41 is filled up by the plastic covering plate 42, able to enhance the bonding strength of the covering plate 42 and the support plate 41. After the saw blade protecting plate 40 is covered on the work table 20, the saw blade 30 can be operated to move up from under the saw blade protecting plate 40 and simultaneously the plastic covering plate 42 at the corresponding position of the saw blade 30 will be cut with a slit 423 exactly large enough for the saw blade 30 to pass therethrough and operate therein, letting the saw blade 30 inserted and fixed in the center portion of the saw blade protecting plate 40 almost leaving no gap between them. Therefore, during sawing of a work piece, wood chips produced cannot drop in the slit 423 between the sawing blade protecting plate 40 and the saw blade 30 and cause an accident, thus insuring safety in a sawing process.

Further, the two bonding members 424 of the covering plate 42 are respectively bonded thereon with the hard and abrasion-resistant steel plate 425 in order to prevent the non-return plate 51 from damaging the plastic covering plate 42 when the non-return plate 51 is moved to collide with the covering plate 42. Furthermore, the saw blade protecting plate 40 is made of the metallic support plate 41 and the plastic covering plate 42 bonded and covered on the support plate 41; therefore, the plastic covering plate 42 is of a certain hardness, not easy to be deformed, and can be shaped with less thickness, able to lower producing cost.

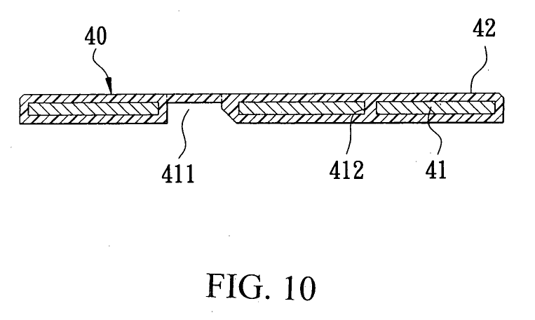

A second preferred embodiment of a saw blade protecting plate for a table sawing machine in the present invention, as shown in FIG. 10, has almost the same function as that described in the first preferred embodiment, except that the plastic covering plate 42 is formed integral and completely covered and bonded on the periphery of the support plate 41 and covers the notch 411 of the support plate 41, thus able to enhance the bonding strength of the covering plate 42 and the support plate 41.

As can be understood from the above description, this invention has the following advantages.

1. The saw blade protecting plate is made of the metallic support plate and the plastic covering plate covered on and supported by the metallic support plate, so the plastic covering plate is hard and not easy to be deformed, able to lower producing cost.

2. The saw blade protecting plate has a portion corresponding with the location of the saw blade formed with a plastic covering plate, which is cut with a lengthwise slit by the saw blade for receiving the saw blade therein; therefore, there is almost no gap between the saw blade and the saw blade protecting plate, thus avoiding wood chips or wood blocks dropping in the slit and causing an accident.

While the preferred embodiments of the invention have been described above, it will be recognized and understood that various modifications may be made therein and the appended claims are intended to cover all such modifications that may fall within the spirit and scope of the invention.

I claim:

1. A saw blade protecting plate of a table sawing machine to be firmly covered on the work table of a table sawing machine, said saw blade protecting plate fitted with a saw blade positioned on said work table: and,
Characterized by said saw blade protecting plate comprising a support plate and a covering plate, said support plate made of metal and having its surface bored with a lengthwise notch preset in length and width, said notch of said support plate corresponding with the location of said saw blade, said covering plate made of plastic able to be cut by said saw blade, said covering plate covered and bonded on said support plate, said covering plate covering said notch of said support plate, said covering plate formed with a smooth surface, said saw blade protecting plate having a portion corresponding with said saw blade formed into a plastic covering plate, said plastic covering plate cut with a lengthwise slit by said saw blade when said saw blade is operated to move up from under said plastic covering plate, said slit exactly large enough for said saw blade to pass therethrough and operate therein, said saw blade exactly inserted in said saw blade protecting plate almost leaving no gap between them.

2. The saw blade protecting plate of a table sawing machine as claimed in claim 1, wherein said covering plate is formed integrally with a peripheral edge, said peripheral edge of said covering plate covered and bonded on the peripheral edge of said support plate.

3. The saw blade protecting plate of a table sawing machine as claimed in claim 1, wherein said covering plate is formed integral and completely covered and bonded on the whole said support plate.

4. The saw blade protecting plate of a table sawing machine as claimed in claim 1, wherein said support plate has its surface bored with a combining hole, said combining hole of said support plate filled with plastic to form a combining member for enhancing the bonding strength of said support plate and said covering plate when said covering plate is injection molded.

5. The saw blade protecting plate of a table sawing machine as claimed in claim 1, wherein said support plate has 2-3 mm thickness.

6. The saw blade protecting plate of a table sawing machine as claimed in claim 1, wherein said covering plate has 2 mm thickness.

7. The saw blade protecting plate of a table sawing machine as claimed in claim 1, wherein said covering plate is provided with two recessed bonding members respectively at the opposite sides of the non-return plate of a protective cover unit for respectively bonding a hard and abrasion-resistant steel sheet thereon.
